(19) United States
(12) Patent Application Publication
(10) Pub. No.: US 2022/0109560 A1
(43) Pub. Date: Apr. 7, 2022

(54) Regional Isolation in an Integrated Cloud Service

(71) Applicant: Google LLC, Mountain View, CA (US)

(72) Inventors: Dan Dennison, Castaic, CA (US); Alexander R. Perry, Santa Monica, CA (US); Aaron S. Joyner, Sawmills, NC (US); Kyle R. Smith, Millwood, NY (US); Hildo P. Biersma, New York, NY (US); David M. Hamilton, San Ramon, CA (US); Peter Kiehtreiber, Campbell, CA (US)

(21) Appl. No.: 17/061,654

(22) Filed: Oct. 2, 2020

(51) Int. Cl. H04L 9/08; H04L 9/32; H04L 29/06; H04L 29/08; H04L 12/24; H04L 12/66

(52) U.S. Cl. CPC H04L 9/088; H04L 9/3247; H04L 63/10; H04L 67/20; H04L 67/28; H04L 12/66; H04L 67/40; H04L 67/1097; H04L 41/0803

(57) ABSTRACT

The present disclosure provides a system for securely maintaining data, wherein the customer has full visibility over all access to that data. In particular, the present disclosure provides for a multi-tenant cloud computing region operated jointly by a cloud platform provider and a local third-party partner. The multi-tenant region includes an isolated region and a non-isolated region, wherein the isolated region includes a proxy controlling access to the isolated region. Defined parameters are stored at the proxy and used to determine whether access to the isolated region should be granted. When requests are granted, credentials encrypted with a regional key are issued to the requester, and the access may be monitored and/or recorded.

### BACKGROUND

Customers can be concerned about who has access to their data. In some instances, customers may even be concerned about a cloud platform administrator's ability to access the customer's data without detection by the customer. However, because the cloud platform administrator is responsible for maintaining the system on which the customer's data is stored, in some instances it is necessary for the administrator to access the data. Therefore, access cannot be cut off completely.

### BRIEF SUMMARY

The present disclosure provides a system for securely maintaining data, wherein the customer has full visibility over all access to that data. In particular, the present disclosure provides for a multi-tenant cloud computing region operated jointly by a cloud platform provider and a local third-party partner.

One aspect of the disclosure provides a cloud computing system, including a proxy in an isolated region of the cloud computing system, wherein the proxy is configured to receive configuration commands from a third party, the configuration commands defining one or more boundary parameters for accessing the region, receive all requests to access administrative capabilities in the region, and determine whether to forward or block the requests based on one or more of the boundary parameters.

The system may further include a cloud administrating computing device connected via a network to the isolated region and at least one non-isolated region in a common authorization domain, each region linked to the network through a gateway and comprising computing processing hardware and storage. The computing processing hardware and storage of the isolated and non-isolated regions is configured to respond to a common set of remote procedure calls (RPCs) from the cloud administrating computing device. The isolated and non-isolated regions may be datacenters, wherein the storage of each of a plurality of the non-isolated datacenters includes information encrypted by a root master key of the cloud computing system and accessible by the administrating computing device, and the storage of the isolated data center includes isolated data encrypted by a regional master key not accessible by the administrating computing device. The isolated datacenter may include a plurality of isolated datacenters, each of the isolated datacenters having a different regional master key.

According to some examples the system may further include a region encryption service storing cryptographic keys designated for the region, wherein all requests forwarded by the proxy are protected by the regional encryption service. The region encryption service may issue credentials that are time-bound and cryptographically signed. The proxy may maintain a log of all requests for access and details in connection with accesses granted by the proxy. The boundary parameters may include national origin of the requester, country of location of the requester, requested action, attached justification, and particular policies set forth by the owner or data-custodian of the region.

Another aspect of the disclosure provides a method for controlling access to an isolated region of a cloud computing system. The method includes receiving, at a proxy within the isolated region, configuration commands from a third party, the configuration commands defining one or more boundary parameters for accessing the region, receiving, by the proxy, all requests to access administrative capabilities in the region, and determining, by the proxy, whether to forward or block the requests based on one or more of the boundary parameters.

The request for access may be received from a cloud administrating computing device connected via a network to the isolated region and at least one non-isolated region in a common authorization domain. Computing processing hardware and storage of the isolated and non-isolated regions may be configured to respond to a common set of remote procedure calls (RPCs) from the cloud administrating computing device.

According to some examples, the method may further include encrypting information stored in the isolated computing region using a regional master key that is not accessible by the administrating computing device. Further, the method may include encrypting information stored in the non-isolated computing region using a root master key of the cloud computing system that is accessible by the administrating computing device. The isolated region may have a different regional master key than a second isolated region.

According to further examples, the method may further include storing, with a region encryption service, cryptographic keys designated for the region, and protecting, with the region encryption service, all requests forwarded by the proxy. The method may yet further include issuing, by the region encryption service, credentials that are time-bound and cryptographically signed.

According to some examples, the method further includes maintaining a log of all requests for access and details in connection with accesses granted by the proxy.

The boundary parameters may include national origin of the requester, country of location of the requester, requested action, attached justification, and particular policies set forth by the owner or data-custodian of the region.

### BRIEF DESCRIPTION OF THE DRAWINGS

FIG. 1 is a block diagram of an example system according to aspects of the disclosure.

FIG. 2 is a block diagram of another example system according to aspects of the disclosure.

FIG. 3 is a block diagram of another example system according to aspects of the disclosure.

FIG. 4 is a block diagram of another example system according to aspects of the disclosure.

FIG. 5 is a block diagram of another example system according to aspects of the disclosure.

FIG. 6 is a flow diagram illustrating an example method according to aspects of the disclosure.

### DETAILED DESCRIPTION

### Overview

The present disclosure provides a system for securely maintaining data, wherein the customer has full visibility over all access to that data. In particular, the present disclosure provides for a multi-tenant cloud computing region operated jointly by a cloud platform provider and a local third-party partner.

The multi-tenant computing region may be an isolated cloud platform region in which all cloud platform services and data can be localized. In some instances, administrative access may be required by the administrators of the cloud platform provider administrator. For example, actions related to monitoring, management, and/or maintenance of the isolated region infrastructure may be required. Such actions may include, for example, deploying software updates, debugging errors, and assisting customers with support issues if requested. Such access may be governed by policies set by the third-party partner, and must be routed through a proxy, which enforces these policies and is operated by the third party partner for the entire region.

The proxy may include a boundary proxy and an operator proxy. The operator proxy allows the third party partner to define the accesses that are allowed by others, including by the cloud platform provider's administrators. For example, the operator proxy may maintain one or more policies set by the third party partner, wherein such policies define the access permitted by the cloud platform provider. For example, such policies may limit the type of access, time of access, duration of access, or any of a number of other parameters. According to some examples, an application programming interface (API) may be provided to the third party partners to define and/or update such policies. When a request for access is received in the isolated region, the operator proxy may determine whether such request is permitted based on the predefined policies. According to some examples, the policy may require direct manual review of the request by the third party partner at the time the determination is being made.

In some examples, the boundary proxy points to a region encryption service. The region encryption service may include hardware security modules (HSMs) inside the datacenter, storing cryptographic keys that are distinct to the isolated region. In other examples, other encryption mechanisms may be implemented, such as cryptographic CPU enclaves, etc. The only system that can cryptographically sign approved access requests with those keys is the region-specific hardware security module. If the proxy allows the cloud platform administrator access, it will issue credentials to the administrator that are time-bound and cryptographically signed. The third party partner is the only one that can tell the proxy when to do that or not.

All access through the proxy is detectable by the third party partner, and therefore the third party partner maintains visibility to all accesses. In some examples, the operator proxy may maintain logs of all accesses into the isolated region. Accordingly, upon request, logs can be generated for the third-party partner indicating what data was accessed, at what time, in which administrative region or country, and by a pseudonym identifying whom.

A common set of remote procedure calls (RPCs) may be used to access the isolated region as well as other, non-isolated regions. The administrative systems in each region expose the same set of RPCs, where those in the isolated region are only accessible via the proxy. In this case, the administrator may manually direct their administrative request to the appropriate proxy, or the administrator may utilize an additional system outside of the isolated region that properly routes each request to the appropriate location. These administrative RPCs expose a simplified view of the systems under management to ease the customer or data-owner's ability to understand what type of access is being requested and the purpose of such access via the attached justification.

The cloud computing system described herein is advantageous in a number of respects. It provides for independent and verifiable control over the cloud platform provider's use of administrative privileges to access administrative functionality in the cloud—namely systems that read and return customer data, or can manipulate customer workloads. It may be particularly beneficial for workloads that are blocked from adopting cloud-based services because current cloud product offerings don't provide sufficient guarantees on customer control over administrative access. It may be used in any of a variety of industries and the public sector, including any that may be subject to regulation, such as banking, healthcare, government, manufacturing, etc.

### Example Systems

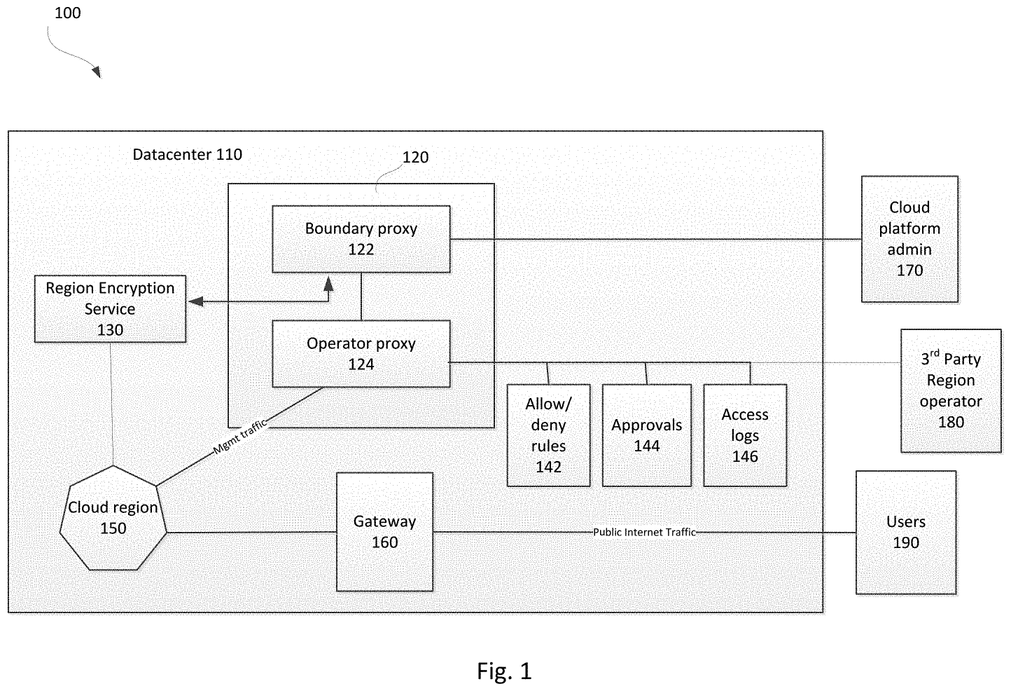

FIG. 1 illustrates an example system 100 for providing data sovereignty with third party oversight for an isolated cloud region 150. Datacenter 110 includes a gateway 160, which allows access to selected services of the cloud region 150. For example, the gateway 160 may allow users 190 to access services of the cloud region 150 over the Internet. Datacenter 110 further includes proxy 120, which allows secure access by a region operator 180 or a cloud platform administrator 170. For example, the cloud platform administrator 170 may need to access one or more virtual machines in the cloud region 150 for maintenance. The proxy 120 defines the types of access that are permitted by the cloud platform administrator 170, and the region operator 180 oversees such access.

The cloud region 150 may be an isolated cloud platform region within a multi-tenant region. The cloud region 150 includes computing devices for providing services on behalf of customers. The customers may be, for example, businesses having websites or applications supported by the computing devices in the cloud region 150. Such devices may include, for example, computing hardware, servers, virtual machines, networking devices, data storage devices, and the like. In the cloud region 150, all cloud platform services and data can be localized.

According to some examples, the proxy 120 includes a boundary proxy 122 and an operator proxy 124. The operator proxy 124 allows the regional operator 180 to define the accesses that are allowed by others, including by the cloud platform provider's administrators 170. For example, the operator proxy 124 may maintain one or more policies, such as admit/deny rules 142, set by the regional operator 180. Such policies or rules 142 may define the access permitted by the cloud platform administrator 170. For example, such policies may limit the type of access, time of access, duration of access, or any of a number of other parameters. According to some examples, an application programming interface (API) may be provided to the region operator 180 to define and/or update such policies. When a request for access is received in the isolated cloud region 150, the operator proxy 124 may determine whether such request is permitted based on the predefined policies.

In some instances, administrative access to the cloud region 150 may be required by the cloud platform provider administrator 170. For example, actions related to monitoring, management, and/or maintenance of the isolated region infrastructure may be required. Such actions may include, for example, deploying software updates, debugging errors, and assisting customers with support issues if requested. Such access may be governed by the policies or rules 142, and must be routed through the proxy 120, which enforces these policies and is operated by the region operator 180.

According to some examples, the operator proxy may track approvals 144 when requests for access are approved. For example, information regarding the requesting entity, type of access requested, time of request, etc. may be stored. In some examples, such information may be used to confirm future requests for access.

All access through the proxy 120 is detectable by the region operator 180, and therefore the region operator 180 maintains visibility to all accesses. In some examples, the operator proxy 124 may maintain logs 146 of all accesses into the cloud region 150. Accordingly, upon request, logs can be generated for the region operator 180 indicating what data was accessed, at what time, in which administrative region or country, and by a pseudonym identifying whom.

The boundary proxy 122 points to a region encryption service 130. The region encryption service 130 may protect information used for accessing the isolated region. For example, the region encryption service 130 may include hardware security modules (HSMs) or cryptographic CPU enclaves inside the datacenter 110 storing cryptographic keys that are distinct to the isolated cloud region 150. The only system that can cryptographically sign approved access requests with those keys is the region encryption service 130. If the proxy 120 allows the cloud platform administrator 170 access, it will issue credentials to the administrator 170 that are time-bound and cryptographically signed. The region operator 180 is the only one that can tell the proxy when to do that or not.

The region operator 180 may be a third party partner, such as a company or individual hired to regulate access to the cloud region 150. The region operator may be responsible for governing access to the computing devices hosting services of a particular customer, multiple customers, or all customers with services supported by the cloud region 150. According to some examples, the region operator 180 may not have access to the cloud region, though the operator 180 is responsible for governing access by others.

The gateway 160 may be, for example, a network appliance or server, which translates cloud storage APIs, such as SOAP or REST, to block-based storage protocols (e.g., iSCSI or Fibre Channel) or file-based interfaces (e.g., network file system (NFS) or server message block (SMB)). The gateway 160 may be deployed as a bare metal hardware appliance, a software appliance supporting different hypervisors, a software on top of an operating system, or in other forms.

A common set of remote procedure calls (RPCs) may be used to access the isolated cloud region 150 as well as other, non-isolated regions. The administrative systems in each region expose the same set of RPCs, where those in the isolated region are only accessible via the proxy 120. In this case, the administrator may manually direct their administrative request to the appropriate proxy, or the administrator may utilize an additional system outside of the isolated region that properly routes each request to the appropriate location. These administrative RPCs expose a simplified view of the systems under management to ease the customer or data-owner's ability to understand what type of access is being requested and the purpose of such access via the attached justification.

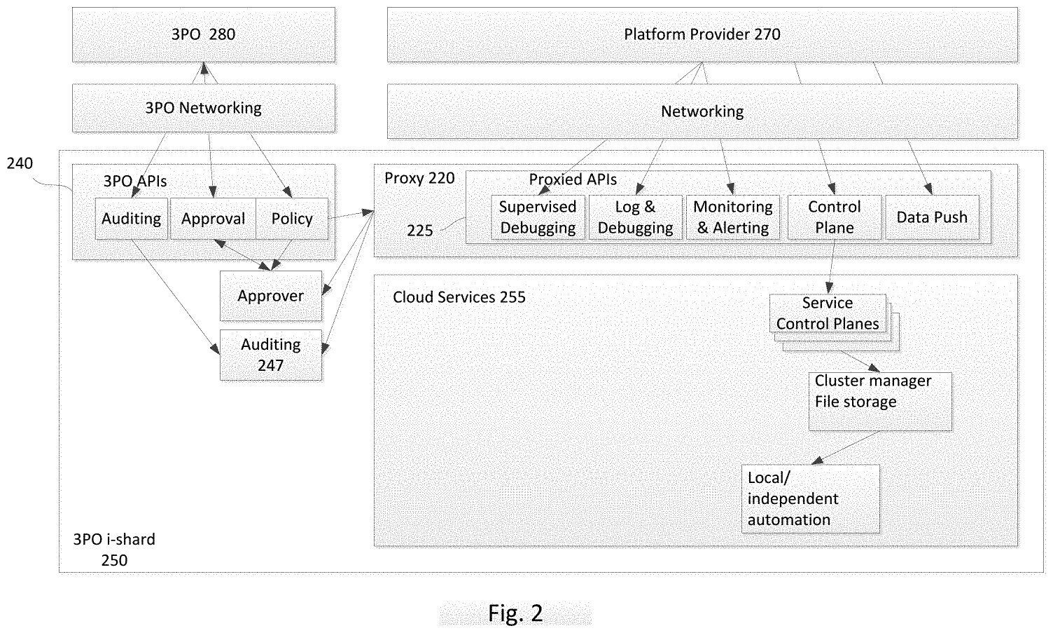

FIG. 2 illustrates another example system for ensuring data sovereignty in an isolated cloud region. In this example, an isolated shard 250 includes cloud services 255, such as service control planes, cluster management, file storage, etc. To access the cloud services 255, a cloud platform provider 270 must access it through a proxy 220. Such access through the proxy 220 is regulated by a third party operator 280, such as through third party operator APIs 240.

The platform provider 270 may be, for example, the organization that provides the computing devices, hardware, virtual machines, etc. that support the cloud services 225. The third party operator 280 may be an independent entity tasked with determining whether access to the shard 250 is permitted.

The proxy 220, as shown, includes a plurality of proxied APIs. These APIs may be executed based on a type of access requested. For example, access to the isolated shard 250 may be requested to perform debugging operations, logging, monitoring etc. In other examples, access to control plane services, such as for cluster management or file storage, may be requested. In other examples, access to data may be requested.

The proxy 220 communicates with the third party APIs 240, which may be executed to determine whether the requested access is permitted. For example, the 3PO APIs 240 may determine whether the requested access meets one or more policies required for approval. The policies may be predetermined by the 3PO 280. For example, the policies may include parameters such as the type of access requested, a duration of access requested, a start or end time of access, an entity requesting access, etc. According to some examples, parts of the policies also may be negotiated with the platform provider 270 to ensure proper customer service levels can be maintained. For example, the 3PO 280 can't take days to review and approve requests causing delays in platform provider 270 fixing a problem. The auditing API in 240 allows the third party operator (3PO) 280 to query or view the contents of auditing system 247. The auditing system 247 provides detailed logging of each request, both as it enters the 3PO API 240 and, if approved, the proxy 220. The auditing system 247 may be tamper-resistant and supports structured (e.g., content-based) as well as time-based search. The auditing system 247 may be made tamper-resistant cryptographically or by putting it into physical control of the region operator.

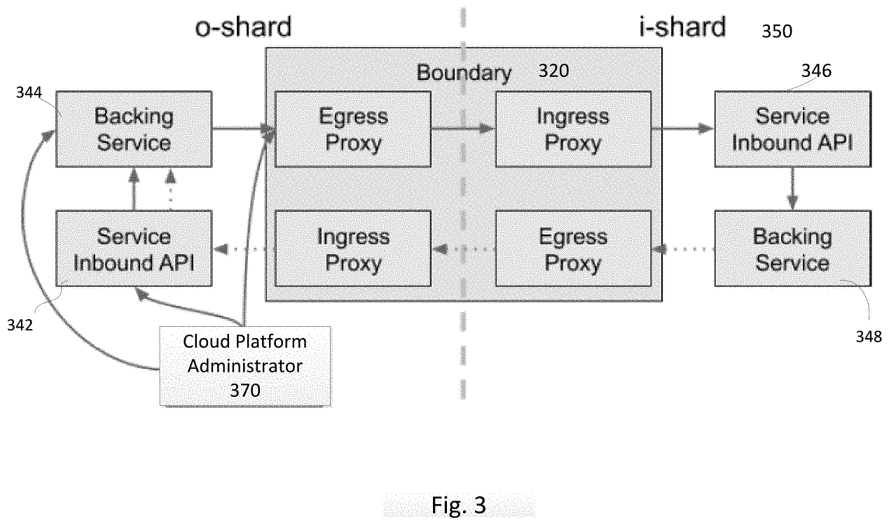

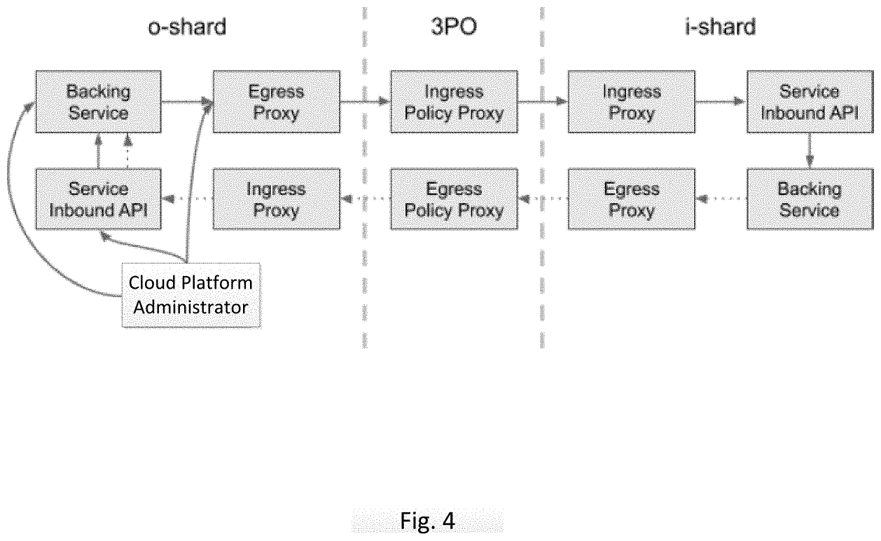

FIGS. 3-4 illustrate further example systems for regulating access to an isolated shard (i-shard) 350. While FIG. 3 illustrates a boundary proxy 320 including ingress and egress proxies for controlling access to the isolated shard 350, FIG. 4 illustrates a third party operator as controlling the access based on policy.

In FIG. 3, the cloud operator can manage the o-shard backing service directly, or through service API 342. The equivalent service in the i-shard does not provide such direct access. Instead, going through service API 346, such access is mediated through the proxy 320.

In some cases the o-shard service needs to communicate with its equivalent i-shard service, such as to issue sub-commands in response to a top-level request, which will go through the boundary proxy 320 to the i-shard service API 346. When the i-shard service needs to return results and/or data to the o-shard, it again flows through the boundary proxy 320. In no case can the cloud platform administrator 370 communicate directly with the i-shard service, neither to send commands nor to receive results or data.

Backing service instances 344, 348 can be managed using the same API. This increases confidence for the customer that the data is being managed in the same way in both locations. Each backing service represents an actual service the cloud administrator 370 is trying to manage. While only one backing service is shown in each of the o-shard and the i-shard, there may actually be any number of backing service instances. Generally each individual backing service will have a diverse control surface, such as an API, which may be hard to secure. The service API provides a more limited control surface that can be exposed.

In FIG. 4, the 3PO policy can be enforced by a separate set of ingress/egress proxies that are not under the control of the cloud platform administrator. In this case, the ingress/egress policy proxy pair performs the role of the Operator Proxy 124 in FIG. 1. The separate ingress/egress policy proxies can be omitted in FIG. 3 because they are effectively invisible to the cloud platform administrator, forwarding requests to the next proxy in the chain, except when a request is denied, in which case the request would not be forwarded.

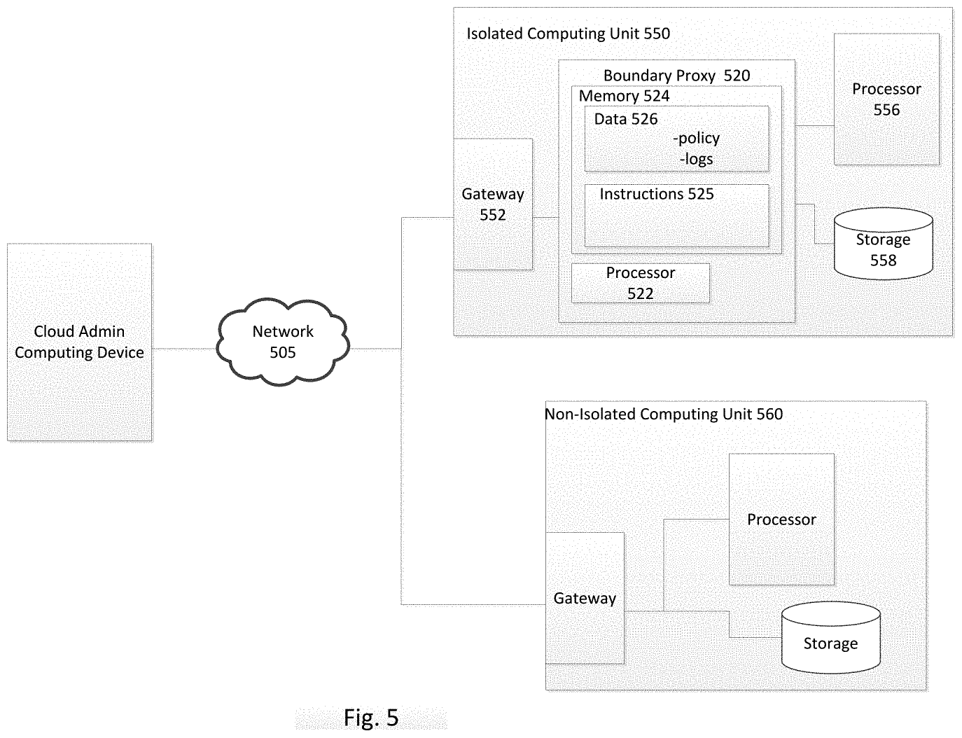

FIG. 5 is a block diagram of another example system according to aspects of the disclosure. In this example, both an isolated computing unit 550 and a non-isolated computing unit 560 are shown. While the non-isolated computing unit 560 may be accessed freely by cloud administrator computing device 570 through network 505, access to the isolated computing unit 550 is restricted. The system of FIG. 5 functions similarly to the system of FIG. 1, but provides an example of another possible arrangement. In particular, each computing unit includes a gateway at an input/output point to a network, and the isolated region includes a proxy in a bypass. The proxy may be a boundary proxy, operator proxy, or some combination. While only one isolated computing unit 550 and one non-isolated computing unit 560 is shown in FIG. 5, it should be understood that multiple isolated and non-isolated units may be interconnected by a network 505.

The network 505, and intervening nodes, may include various configurations and protocols including the Internet, World Wide Web, intranets, virtual private networks, wide area networks, local networks, private networks using communication protocols proprietary to one or more companies, Ethernet, WiFi (e.g., 702.71, 702.71b, g, n, or other such standards), and HTTP, and various combinations of the foregoing. Such communication may be facilitated by a device capable of transmitting data to and from other computers, such as modems (e.g., dial-up, cable or fiber optic) and wireless interfaces.

Each of the isolated and non-isolated computing units 550, 560 may include a gateway 552, one or more processors 556, and storage unit 558. The isolated computing unit 550 further includes a proxy 520 used to control and monitor access to the processor 556 or storage 558 in the isolated computing unit 550. The proxy 520 may include a processor 522, memory 524, and other components.

The isolated unit 550 may include any type of non-transitory computer readable medium capable of storing information accessible by a processor, such as a hard-drive, solid state drive, tape drive, optical storage, memory card, ROM, RAM, DVD, CD-ROM, write-capable, and read-only memories. The isolated unit 550 may be a single computing device or a plurality of computing devices, such as hard drives, random access memory, disks, disk arrays, tape drives, etc. The isolated unit 550 may implement any of a number of architectures and technologies, including, but not limited to, direct attached storage (DAS), network attached storage (NAS), storage area networks (SANs), fibre channel (FC), fibre channel over Ethernet (FCoE), mixed architecture networks, or the like. Further, in some examples the isolated unit 550 may include virtualized or containerized environments. For example, the isolated unit 550 may include one or more virtual machines running on a host machine. The isolated unit 550 may store, for example, data files, documents, code, schemas, persistence frameworks, applications, or any of a variety of other information or tools typically stored in databases.

The memory 524 can store information accessible by the processor 522, including instructions 525 that can be executed by the processor 522. Memory can also include data 526 that can be retrieved, manipulated or stored by the processor 522. The memory 524 may be a type of non-transitory computer readable medium capable of storing information accessible by the processor 522, such as a hard-drive, solid state drive, tape drive, optical storage, memory card, ROM, RAM, DVD, CD-ROM, write-capable, and read-only memories.

The instructions 525 can be a set of instructions executed directly, such as machine code, or indirectly, such as scripts, by the processor 522. In this regard, the terms “instructions,” “steps” and “programs” can be used interchangeably herein. The instructions 525 can be stored in object code format for direct processing by the processor 522, or other types of computer language including scripts or collections of independent source code modules that are interpreted on demand or compiled in advance.

The instructions 525 may be executed to determine, in response to a request for access, whether access should be permitted. The instructions 525 may further be executed to admit or deny access, and to maintain records of the accesses requested and granted.

The data 526 can be retrieved, stored or modified by the processor 522 in accordance with the instructions 525. For instance, although the system and method is not limited by a particular data structure, the data 526 can be stored in computer registers, in a relational database as a table having a plurality of different fields and records, or XML documents. The data 526 can also be formatted in a computer-readable format such as, but not limited to, binary values, ASCII or Unicode. Moreover, the data 526 can include information sufficient to identify relevant information, such as numbers, descriptive text, proprietary codes, pointers, references to data stored in other memories, including other network locations, or information that is used by a function to calculate relevant data.

The data 526 may include policies used to determine whether a request for access from the cloud administrator computing device 570 should be granted. The data may further include information relating to access by the cloud administrator computing device 570, such as logs of the type of access, time, duration, device accessing the isolated unit, devices within the isolated unit that were accessed, etc.

The processor 522 can be a well-known processor or other lesser-known types of processors. Alternatively, the processor 522 can be a dedicated controller such as an ASIC. While the processor 522 is shown as being included within the proxy 520, it should be understood that the processor 522 may have a separate physical housing external to the proxy 520. According to some examples, the processor 522 may be one of the computing devices supporting cloud services in the isolated computing unit 550, such as the processor 556.

Although FIG. 5 functionally illustrates the processor 522 and memory 524 as being within the same block, the processor 522 and memory 524 may actually include multiple processors and memories that may or may not be stored within the same physical housing. For example, some of the instructions 525 and data 526 can be stored on a removable CD-ROM and others within a read-only computer chip. Some or all of the instructions and data can be stored in a location physically remote from, yet still accessible by, the processor 522. Similarly, the processor 522 can actually include a collection of processors, which may or may not operate in parallel.

### Example Methods

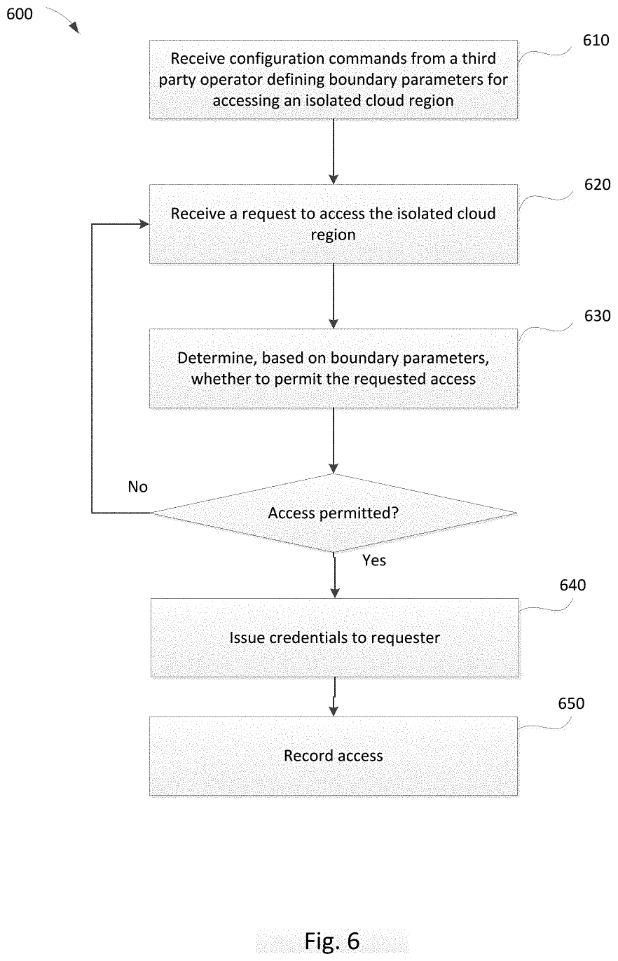

FIG. 6 is a flow diagram illustrating an example method 600 of controlling access to an isolated cloud region. The method may be performed by a proxy at a physical location of the cloud region, such as the proxy described in the examples above. While operations of the method 600 are described in a particular order, it should be understood that in some instances the order may be modified or operations may be performed simultaneously. Moreover, operations may be added or omitted.

In block 610, configuration commands are received, wherein the configuration commands are used to define boundary parameters for accessing the isolated region. The configuration commands may be received from a third party operator that is charged with overseeing access to the cloud region. In some examples, the configuration commands may be received from other sources, such as an owner of the cloud services supported by the isolated region. The boundary parameters may include, for example, policies or rules for determining whether access should be permitted. According to some examples, the boundary parameters may define permissions based on national origin of the requester, country of location of the requester, requested action, attached justification, and particular policies set forth by the third party operator or data-custodian of the region. The boundary parameters may be stored at the proxy. According to some examples, the boundary parameters may be applied through execution of an API.

In block 620, a request for access to the isolated cloud region is received by the proxy. The request may indicate the entity requesting access, the type of access requested, and other information, such as the time, duration, etc. of the access. The type of access may include, for example, which devices in the cloud region will be accessed, the purpose such as whether it is for maintenance, customer support, updates, etc., any changes to be made, etc. According to some examples, the request may be an RPC, such as the same type of RPC that would be used to access a non-isolated region.

In block 630, it is determined, based on the boundary parameters, whether to grant the request for access. For example, it may be determined whether the request meets the policies or rules for which access is allowed. If access is denied, the requesting entity may be informed and the method may return to block 620.

If access is permitted, in block 640 the proxy may issue to the requesting entity cryptographically signed credentials for accessing the isolated cloud region. The credentials may be time bound, for example based on the requested duration of access, such that the credentials expire after the requested duration and the requesting entity will no longer have access. According to some examples, only access in accordance with the request is allowed. For example, if the request was to perform maintenance on a particular virtual machine, only that particular activity is permitted. Other activities, such as accessing data, may be blocked.

In block 650, the access activities by the requesting entity may be monitored and/or recorded by the proxy. For example, the proxy may maintain a log of the devices accessed, actions performed during the access, time of access, etc. The proxy may have complete visibility as to the access by the requesting entity.

Unless otherwise stated, the foregoing alternative examples are not mutually exclusive, but may be implemented in various combinations to achieve unique advantages. As these and other variations and combinations of the features discussed above can be utilized without departing from the subject matter defined by the claims, the foregoing description of the embodiments should be taken by way of illustration rather than by way of limitation of the subject matter defined by the claims. In addition, the provision of the examples described herein, as well as clauses phrased as “such as,” “including” and the like, should not be interpreted as limiting the subject matter of the claims to the specific examples; rather, the examples are intended to illustrate only one of many possible embodiments. Further, the same reference numbers in different drawings can identify the same or similar elements.

1. A cloud computing system, comprising:
a proxy in an isolated region of the cloud computing system, wherein the proxy is configured to:
receive configuration commands from a third party, the configuration commands defining one or more boundary parameters for accessing the region;
receive all requests to access administrative capabilities in the region; and
determine whether to forward or block the requests based on one or more of the boundary parameters.

2. The cloud computing system of claim 1, further comprising:
a cloud administrating computing device connected via a network to the isolated region and at least one non-isolated region in a common authorization domain, each region linked to the network through a gateway and comprising computing processing hardware and storage.

3. The system of claim 2, wherein the computing processing hardware and storage of the isolated and non-isolated regions is configured to respond to a common set of remote procedure calls (RPCs) from the cloud administrating computing device.

4. The system of claim 2, where the isolated and non-isolated regions comprise datacenters.

5. The system of claim 4, wherein:
the storage of each of a plurality of the non-isolated datacenters comprises information encrypted by a root master key of the cloud computing system and accessible by the administrating computing device, and
the storage of the isolated data center comprises isolated data encrypted by a regional master key not accessible by the administrating computing device.

6. The system of claim 5, where the isolated datacenter comprises a plurality of isolated datacenters, each of the isolated datacenters having a different regional master key.

7. The system of claim 1, further comprising a region encryption service storing cryptographic keys designated for the region, wherein all requests forwarded by the proxy are protected by the regional encryption service.

8. The system of claim 7, wherein the region encryption service issues credentials that are time-bound and cryptographically signed.

9. The system of claim 1, wherein the proxy maintains a log of all requests for access and details in connection with accesses granted by the proxy.

10. The system of claim 1, wherein the boundary parameters include national origin of the requester, country of location of the requester, requested action, attached justification, and particular policies set forth by the owner or data-custodian of the region.

11. A method for controlling access to an isolated region of a cloud computing system, the method comprising:
receiving, at a proxy within the isolated region, configuration commands from a third party, the configuration commands defining one or more boundary parameters for accessing the region;
receiving, by the proxy, all requests to access administrative capabilities in the region; and
determining, by the proxy, whether to forward or block the requests based on one or more of the boundary parameters.

12. The method of claim 11, wherein the request for access is received from a cloud administrating computing device connected via a network to the isolated region and at least one non-isolated region in a common authorization domain.

13. The method of claim 12, wherein computing processing hardware and storage of the isolated and non-isolated regions is configured to respond to a common set of remote procedure calls (RPCs) from the cloud administrating computing device.

14. The method of claim 12, further comprising encrypting information stored in the isolated computing region using a regional master key that is not accessible by the administrating computing device.

15. The method of claim 14, further comprising encrypting information stored in the non-isolated computing region using a root master key of the cloud computing system that is accessible by the administrating computing device.

16. The method of claim 14, where the isolated region has a different regional master key than a second isolated region.

17. The method of claim 11, further comprising:
storing, with a region encryption service, cryptographic keys designated for the region; and
protecting, with the region encryption service, all requests forwarded by the proxy.

18. The method of claim 17, further comprising issuing, by the region encryption service, credentials that are time-bound and cryptographically signed.

19. The method of claim 11, further comprising maintaining a log of all requests for access and details in connection with accesses granted by the proxy.

20. The method of claim 11, wherein the boundary parameters include national origin of the requester, country of location of the requester, requested action, attached justification, and particular policies set forth by the owner or data-custodian of the region.
